(19) United States
(12) Patent Application Publication
(10) Pub. No.: US 2025/0022240 A1
(43) Pub. Date: Jan. 16, 2025

(54) MULTI-ROOM CAPTURE METHOD AND APPARATUS, DEVICE, MEDIUM AND PROGRAM PRODUCT

(71) Applicant: Beijing Zitiao Network Technology Co., Ltd., Beijing (CN)

(72) Inventor: Ziyuan LIU, Beijing (CN)

(21) Appl. No.: 18/771,093

(22) Filed: Jul. 12, 2024

(30) Foreign Application Priority Data
Jul. 14, 2023 (CN) 202310871212.6

(51) Int. Cl. G06T 19/20; G06V 20/52

(52) U.S. Cl. CPC G06T 19/20; G06V 20/52; G06T 2219/2004; G06T 2219/2016

(57) ABSTRACT

Embodiments of the present application provide a multi-room capture method and apparatus, a device, a medium and a program product. The method includes: displaying a room capture interface in response to a room capture trigger instruction, the room capture interface including information of uncaptured rooms of a target space, and an environmental map of the target space being associable with anchors of a plurality of captured rooms in the target space; according to a multi-room capture policy, capturing a target room selected by a user; and updating environmental data of the environmental map according to a capture result of the target room, and associating the anchor of the target room with the environmental map.

### CROSS-REFERENCE TO RELATED APPLICATION(S)

This application claims priority to Chinese Application No. 202310871212.6 filed Jul. 17, 2023, the disclosure of which is incorporated herein by reference in its entity.

### FIELD

Embodiments of the present application relate to the field of virtual reality, and in particular to a multi-room capture method and apparatus, a device, a medium and a program product.

### BACKGROUND

Extended reality (XR) refers to combining the reality with the virtuality via a computer, so as to create a virtual environment in which human-computer interaction can be implemented, and the XR may also be a general term of a plurality of technologies such as virtual reality (VR), augmented reality (AR), and mixed reality (MR). By fusing the visual interaction technologies of the three realities, an “immersive feeling” of seamless transition between a virtual world and a real world is brought to an experiencer.

In an MR scene, locations of objects such as a floor, a wall space, a ceiling and furniture in a room are sequentially captured in a room capture manner, some game plays may be derived in an MR space based on a capture technology, for example, a virtual sphere is ejected to a real space to collide back. In an existing solution, in a multi-room scene, an environmental map needs to be created for each room, and a plurality of rooms correspond to a plurality of environmental maps. During a running process of an MR application, after a user moves from one room to another room, the environmental map of the new room needs to be reused for positioning.

The positioning of the environmental map requires a certain time, so that the user cannot normally use the MR application during the positioning process of the environmental map, resulting in poor user experience.

### SUMMARY

Embodiments of the present application provide a multi-room capture method and apparatus, a device, a medium and a program product. A plurality of rooms can be captured on an environmental map, during a use process of an MR application, only once positioning needs to be performed on the environmental map. When a user moves between different rooms, it is not necessary to reposition the environmental map, and it only needs to switch anchors of the rooms. In addition, according to a multi-room capture result, richer functions or game plays may be provided for the MR application, thereby improving the user experience.

In a first aspect, an embodiment of the present application provides a multi-room capture method, including: displaying a room capture interface in response to a room capture trigger instruction, wherein the room capture interface comprises information of uncaptured rooms of a target space, and an environmental map of the target space is associable with anchors of a plurality of captured rooms within the target space; in response to a selection operation by a user on an uncaptured target room in the room capture interface, capturing the target room according to a multi-room capture policy; and updating environmental data of the environmental map according to a capture result of the target room, and associating an anchor of the target room with the environmental map.

In some embodiments, the multi-room capture policy includes the following: closed spaces of any two captured rooms of the environmental map do not overlap with each other.

In some embodiments, the multi-room capture policy further includes the following: a capture box of furniture within a room does not exceed the closed space of the room.

In some embodiments, capturing the target room according to the multi-room capture policy includes: acquiring an image corresponding to the target room, and capturing, according to the image corresponding to the target room, the target room in an order of a floor, a wall space, a ceiling and furniture, wherein the closed space of the target room is formed by connecting capture lines of the floor, the wall space and the ceiling of the target room; capturing the closed space of the target room; and in response to detecting that a target capture line of the closed space of the target room overlaps with the closed space of a captured room of the environmental map, outputting first prompt information, wherein the first prompt information is used for prompting a location error of the target capture line, and/or prompting to adjust a location of the target capture line to a corrected location.

In some embodiments, capturing the target room according to the multi-room capture policy includes: acquiring an image corresponding to the target room, and capturing, according to the image corresponding to the target room, the target room in an order of a floor, a wall space, a ceiling and furniture, wherein the closed space of the target room is formed by connecting capture lines of the floor, the wall space and the ceiling of the target room; and in response to detecting that a capture box of target furniture within the target room exceeds the closed space of the target room, outputting second prompt information, wherein the second prompt information is used for prompting a capture error of the target furniture, and/or prompting to adjust the capture box of the target furniture.

In some embodiments, acquiring the image corresponding to the target room, and capturing, according to the image corresponding to the target room, the target room in the order of the floor, the wall space, the ceiling and the furniture includes: determining, according to the image corresponding to the target room, a perspective image corresponding to the target room; displaying the perspective image corresponding to the target room and a closed floor area or a closed space of the captured room within the target space; and capturing the target room in the order of the floor, the wall space, the ceiling and the furniture.

In some embodiments, capturing the target room in the order of the floor, the wall space, the ceiling and the furniture includes: capturing a capture object within the target room, synchronously displaying a semitransparent mask layer on a capture plane according to the formation of the capture plane of the capture object that is being captured, wherein a semitransparent mask layer is displayed on a capture plane of the captured object within the target room.

In some embodiments, associating the anchor of the target room with the environmental map includes: generating anchor information of the target room, and storing the anchor information of the target room by using an identifier of the target room as an index; and establishing an association relationship between the identifier of the target room and an identifier of the environmental map.

In some embodiments, the method further includes: in response to receiving a first instruction, positioning the environmental map according to the environmental data of the environmental map; in response to determining that the positioning of the environmental map succeeds, determining, according to the identifier of the environmental map, identifiers of a plurality of captured rooms that have been associated with the environmental map; acquiring, according to the identifiers of the plurality of captured rooms that have been associated with the environmental map, anchor information of all or part of the plurality of captured rooms that have been associated with the environmental map; and displaying acquired content of the captured rooms according to the acquired anchor information of the captured rooms.

In some embodiments, acquiring, according to the identifiers of the plurality of captured rooms that have been associated with the environmental map, the anchor information of all or part of the plurality of captured rooms that have been associated with the environmental map, includes: determining, according to a loading rule and from the identifiers of the plurality of captured rooms that have been associated with the environmental map, an identifier of a second captured room to be loaded; and loading the anchor information of the second captured room into a memory according to the identifier of the second captured room.

In some embodiments, displaying the acquired content of the captured rooms according to the acquired anchor information of the captured rooms includes: determining, according to a display rule, an identifier of a first captured room to be displayed; determining, according to the identifier of the first captured room and from the memory, an anchor of the captured room to be displayed; and displaying the content of the first captured room according to the anchor information of the first captured room.

In some embodiments, the method further includes: in response to detecting that the user moves from a third captured room to a fourth captured room, acquiring anchor information of the fourth captured room according to an identifier of the fourth captured room; and displaying the content of the fourth captured room according to the anchor information of the fourth captured room.

In some embodiments, the method further includes: in response to detecting that the user moves from the third captured room to the fourth captured room, closing the content of the third captured room.

In some embodiments, displaying the content of the fourth captured room according to the anchor information of the fourth captured room includes: according to the anchor information of the fourth captured room, displaying the content of the fourth captured room, and displaying a semitransparent mask layer on a capture plane of a captured object within the fourth captured room.

In some embodiments, the method further includes: in response to detecting that the user moves from the third captured room to the fourth captured room, closing the content of the third captured room, or displaying the content of the third captured room, and closing the mask layer of the third captured room.

In some embodiments, the method further includes: displaying a first management interface in an extended reality space in response to a second instruction, wherein the first management interface includes a space list of captured spaces of the user, a room list of captured rooms of the captured spaces, and a 2D view of a space layout of a first captured space, and the first captured space belongs to a space of the captured spaces of the user.

In some embodiments, the method further includes: displaying a 3D view of the space layout of the first captured space in the extended reality space in response to a third instruction.

In some embodiments, the first captured space is a space where the user is located currently, and an identifier of a current location of the user is further displayed in the 2D view of the space layout the first captured space.

Displaying the 3D view of the space layout of the first captured space in response to the third instruction includes: displaying the 3D view of the space layout of the first captured space in the first management interface in response to detecting that the user moves from a first room to a second room in the first captured space.

In some embodiments, the method further includes: displaying, in the extended reality space, a 3D model of the first room in the first captured space in response to a 3D model evocation instruction.

In some embodiments, displaying, in the extended reality space, the 3D model of the first room in the first captured space includes: hiding the first management interface in the extended reality space, and displaying the 3D model of the first room.

In some embodiments, the method further includes: upon detecting a first operation, controlling the 3D model of the first room to enter an editing state, wherein the 3D model of the first room is displayed with a preset effect after the 3D model of the first room enters the editing state; and upon detecting a second operation, controlling the 3D model of the first room to rotate.

In some embodiments, the first captured space is a space where the user is located currently, the first room is a room where the user is located currently, and the method further includes: in response to detecting that a rotation angle of a head-mounted device is greater than a preset angle or the 3D model of the first room exceeds a field of view of the user, controlling, according to a current location of the user, the 3D model of the first room to move to a preset location within the field of view of the user.

In some embodiments, the method further includes: displaying a second management interface in the extended reality space in response to a fourth instruction, wherein the second management interface comprises a space list of captured spaces of a user, a room list of captured rooms of the captured spaces, and management controls of the captured rooms of the captured spaces; and in response to a second operation by the user on the management control of a fifth captured room of the captured space, performing the following operations on the fifth captured room: room modification and room deletion, wherein the room modification comprises one or more of the following modification operations: modifying a name of a room, resetting a space capture result of a room, adding furniture within a room, deleting furniture within a room, or modifying an anchor within a room.

In some embodiments, the second management interface further includes a room adding control, and the method further includes: adding a capturable room to the target space in response to a third operation by the user on the room adding control.

In a second aspect, an embodiment of the present application provides a multi-room capture apparatus, including: a display module, configured to display a room capture interface in response to a room capture trigger instruction, wherein the room capture interface includes information of uncaptured rooms of a target space, and an environmental map of the target space is associable with anchors of a plurality of captured rooms within the target space; a capture module, configured to: in response to a selection operation by a user on an uncaptured target room in the room capture interface, capture the target room according to a multi-room capture policy; and an update module, configured to update environmental data of the environmental map according to a capture result of the target room, and associate the anchor of the target room with the environmental map.

In a third aspect, an embodiment of the present application provides an XR device, including a processor and a memory, wherein the memory is configured to store a computer program, and the processor is configured to call and run the computer program stored in the memory, so as to execute the method in any one of the first aspect.

In a fourth aspect, an embodiment of the present application provides a computer-readable storage medium, wherein the computer-readable storage medium is configured to store a computer program, and the computer program causes a computer to execute the method in any one of the first aspect.

In a fifth aspect, an embodiment of the present application provides a computer program product, including a computer program, wherein the computer program implements, when executed by a processor, the method in any one of the first aspect.

According to the multi-room capture method and apparatus, the device, the medium and the program product provided in the embodiments of the present application, the method includes: displaying a room capture interface in response to a room capture trigger instruction, wherein the room capture interface includes information of uncaptured rooms of a target space, and an environmental map of the target space is associable with anchors of a plurality of captured rooms within the target space; according to a multi-room capture policy, capturing a target room selected by a user; and updating environmental data of the environmental map according to a capture result of the target room, and associating the anchor of the target room with the environmental map. In the method, one environmental map is created for a plurality of rooms in a target space; with the capture of the rooms in the target space, the environmental map is continuously increased; and the environmental map is associable with the anchors of a plurality of captured rooms in the target space. During the use process of the MR application, only once positioning needs to be performed on the environmental map. When the user moves between different rooms, it is not necessary to reposition the environmental map, and it only needs to switch the anchors of the rooms, thereby improving the user experience.

### BRIEF DESCRIPTION OF THE DRAWINGS

To illustrate technical solutions in the embodiments of the present invention more clearly, a brief introduction on the drawings which are needed in the description of the embodiments is given below. Apparently, the drawings in the description below are merely some of the embodiments of the present invention, based on which other drawings may be obtained by those ordinary skilled in the art without any creative effort.

FIG. 1 is a flowchart of a multi-room capture method provided in Embodiment 1 of the present application;

FIG. 2 is a schematic diagram of a UI after a user opens a room capture function for the first time;

FIG. 3 is a schematic diagram of a captured room of a target space;

FIG. 4 is a schematic diagram of a location relationship between a closed floor area of a captured room in the target space and a wall space of a target room;

FIG. 5 is a schematic diagram of a mask layer of a captured wall space in the target room;

FIGS. 6A and 6B are a schematic diagram of a change of the UI during a room capture process;

FIG. 7 is a flowchart of a multi-room capture method provided in Embodiment 2 of the present application;

FIG. 8 is a flowchart of a multi-room capture method provided in Embodiment 3 of the present application;

FIG. 9 is a schematic diagram of the UI involved in a management flow of a captured room;

FIG. 10 is a flowchart of a multi-room capture method provided in Embodiment 4 of the present application;

FIG. 11 is one schematic diagram of a first management interface;

FIG. 12 is another schematic diagram of the first management interface;

FIG. 13 is one schematic diagram of a 3D view of a space layout of a first captured space displayed in the first management interface;

FIG. 14 is another schematic diagram of the 3D view of the space layout of the first captured space displayed in the first management interface;

FIG. 15 is a schematic display diagram of a 3D model of a room;

FIG. 16 is a schematic structural diagram of a multi-room capture apparatus provided in Embodiment 5 of the present application; and

FIG. 17 is a schematic structural diagram of an XR device provided in Embodiment 6 of the present application.

### DETAILED DESCRIPTION OF EMBODIMENTS

A clear and complete description of the technical solutions in the embodiments of the present invention will be given below, in combination with the drawings in the embodiments of the present invention. Apparently, the embodiments described below are merely a part, but not all, of the embodiments of the present invention. All of other embodiments, obtained by those ordinary skilled in the art based on the embodiments in the present invention without any creative effort, fall into the protection scope of the present invention.

It should be noted that, the terms “first” and “second” and the like in the specification, claims and the above-mentioned drawings of the present invention are used for distinguishing similar objects, and are not necessarily used for describing a specific sequence or precedence order. It should be understood that the data used in this way may be interchanged under appropriate circumstances, so that the embodiments of the present invention described herein may be implemented in an order other than those illustrated or described herein. In addition, the terms “including” and “having”, and any variations thereof are intended to cover non-exclusive inclusions, for example, processes, methods, systems, products or devices including a series of steps or units are not necessarily limited to those clearly listed steps or units, but may include other steps or units that are not clearly listed or are inherent to these processes, methods, products or devices.

In order to conveniently understand the embodiments of the present application, before describing the embodiments of the present application, some concepts involved in all embodiments of the present application are first appropriately explained, which are specifically as follows:

A multi-room capture method provided in the embodiments of the present application may be applied to an XR device, and the XR device includes, but is not limited to, a VR device, an AR device and an MR device.

VR: a technology for creating and experiencing a virtual world, which calculates and generates a virtual environment, is a kind of multi-source information (the virtual reality mentioned herein at least includes visual perception, may further include auditory perception, tactile perception and motion perception, even further includes taste perception, olfactory perception, and the like), implements fused and interactive three-dimensional dynamic simulation of sceneries and entity behaviors of the virtual environment, so that a user is immersed in a simulated virtual reality environment, and implements the application of a plurality of virtual environments such as maps, games, videos, education, medical treatment, simulation, collaborative training, sales, assistant manufacturing, maintenance and repair, etc.

AR: an AR scenery refers to a simulated scenery in which at least one virtual object is overlaid on a physical scenery or a representation thereof. For example, an electronic system may be provided with an opaque display and at least one imaging sensor, the imaging sensor is used for capturing images or videos of the physical scenery, and these images or videos are representations of the physical scenery. The system combines the images or videos with a virtual object and displays the combination on the opaque display. An individual uses the system to indirectly view the physical scenery via the images or videos of the physical scenery and to observe the virtual object overlaid on physical scenery. When the system uses one or more image sensors to capture the images of the physical scenery and uses those images to present the AR scenery on the opaque display, the displayed images are referred to as transparent video transmission. Alternatively, the electronic system for displaying the AR scenery may be provided with a transparent or semitransparent display through which the individual may directly view the physical scenery. The system may display a virtual object on the transparent or semitransparent display, so that the individual uses the system to view the virtual object overlaid on the physical scenery. As another example, the system may include a projection system for projecting the virtual object into the physical scenery. The virtual object may be, for example, projected on a physical surface or as a hologram, so that the individual uses the system to view the virtual object overlaid on the physical scenery. Specifically, the AR is a technology, which, during the process of capturing an image by a camera, calculates a camera attitude parameter of the camera in a real world (or referred to as a three-dimensional world and a real world) in real time, and adds a virtual element to the image collected by the camera according to the camera attitude parameter. The virtual element includes, but it not limited to, an image, a video and a three-dimensional model. The goal of the AR technology is to socket, on a screen, the virtual world on the real world for interaction.

MR: which presents virtual scene information in a real scene, and establishes an interactive feedback information loop between a real world, a virtual world and a user, so as to enhance the sense of reality of the user experience. For example, a sensory input (e.g., a virtual object) created by a computer is integrated with a sensory input from a physical scenery or a representation thereof in a simulated scenery; and in some MR sceneries, the sensory input created by the computer may adapt to a change in sensory input from the physical scenery. In addition, some electronic systems for presenting the MR scenery may monitor an orientation and/or location relative to the physical scenery, so that the virtual object can interact with a real object (i.e., a physical element from the physical scenery or a representation thereof). For example, the system may monitor motion, so that a virtual plant appears stationary with respect to a physical building.

A virtual reality device refers to a terminal for implementing a virtual reality effect, and may generally be provided as a pair of glasses, a head mount display (HMD for short), and contact lenses, so as to implement visual perception and other forms of perception. Of course, the implementation form of the virtual reality device is not limited thereto, and the virtual reality device may be further miniaturized or enlarged according to actual needs.

Optionally, the virtual reality device (i.e., the XR device) recorded in the embodiments of the present application may include, but is not limited to, the following several types:
1) A mobile virtual reality device, which supports to set a mobile terminal (e.g., a smart phone) in various manners (e.g., a head mount display provided with a dedicated card slot), is connected with the mobile terminal in a wired or wireless manner, so that the mobile terminal performs related calculation of a virtual reality function and outputs data to the mobile virtual reality device, for example, a virtual reality video is viewed by an APP of the mobile terminal.
2) An all-in-one machine virtual reality device, which is provided with a processor for performing related calculation of a virtual function, thereby having an independent virtual reality input and output function and there being no need to connect with a PC terminal or a mobile terminal, so that the degree of freedom for use is high.
3) A personal computer virtual reality (PCVR) device, which performs related calculation and data output of the virtual reality function by using the PC terminal, an external personal computer virtual reality device uses the data output by the PC terminal to achieve the effect of virtual reality.

The multi-room capture method provided in the present embodiment may be applied to an MR scene, and an MR application (app) assigns, by using a room capture manner, physical attributes (including, but not limited to, occlusion and collision) to a floor, a wall space, a ceiling and furniture in a space, and meanwhile sets, by using a spatial anchor technology, an anchor in an environmental map corresponding to a real environment. The MR application calls a capture result of the space, and displays the content of the MR application to the user.

In the MR scene, the XR device performs VST processing on an image of a real environment to obtain a perspective image corresponding to the real environment, the perspective image corresponding to the real environment is a 3D image, and the perspective image corresponding to the real environment is displayed by a display of the XR device. The user can visually see the real environment via the display, and for a head mount XR device, the user may accurately see an external real environment without removing the head mount XR device, thereby facilitating the interaction of the user with the external real environment.

The MR application performs space capture by using a VST technology, and an environmental map obtained by space capture is also referred to as a virtual map or a virtual scene.

In the prior art, in a multi-room scene, for example, the user uses the XR device at home, there are a plurality of rooms in the house, an environmental map needs to be created for each room, and the plurality of rooms correspond to a plurality of environmental maps. When the user enters a room 2 from a room 1, the environmental map corresponding to the room 1 needs to be switched to the environmental map corresponding to the room 2, that is, positioning needs to be performed on the environmental maps again to position to the environmental map corresponding to the room 2, and the positioning of the environmental map requires a certain time, so that the user cannot normally use the MR application during the positioning process of the environmental map. The positioning of the environmental map is also referred to as recognition of the environmental map or retrieval or space recognition of the environmental map.

In order to solve the problems in the prior art, an embodiment of the present application provides a multi-room capture method, in which one environmental map for a plurality of rooms in a target space, the environmental map is continuously increased along with the capture of the rooms in the target space, and the environmental map is associable with a plurality of captured rooms in the target space. During a use process of the MR application, only once positioning needs to be performed on the environmental map, and when the user moves between different rooms, there is no need to reposition the environmental map.

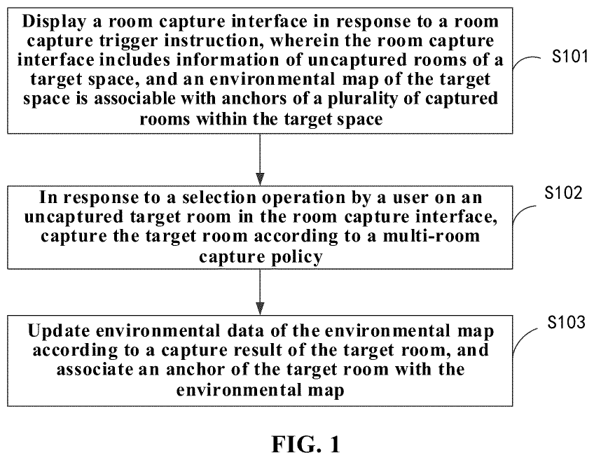

FIG. 1 is a flowchart of a multi-room capture method provided in Embodiment 1 of the present application, and the method is applied to the XR device. As shown in FIG. 1, the method provided in the present embodiment includes the following steps.
S101: a room capture interface is displayed in response to a room capture trigger instruction, the room capture interface includes information of an uncaptured room of a target space, and an environmental map of the target space is associable with anchors of a plurality of captured rooms in the target space.

The user wears a head mount device and opens a capture function of the MR application. For an integrated XR device, the XR device is the head mount device, and for a split XR device (e.g., the above mobile virtual reality device or the PCVR device), the XR device includes a head mount device and another external device.

After the user opens the capture function of the MR application, capture options are displayed on a UI corresponding to the capture function, and then the user may perform click, double-click, long-press and other operations on the capture options. Upon detecting the click, double-click, long-press and other operations by the user on the capture options, the XR device generates a space capture trigger instruction, and displays a space capture interface according to the space capture trigger instruction.

The space capture interface includes information of uncaptured rooms in a target space, and the target space includes a plurality of capturable rooms.

In one implementation, the number of capturable rooms may be a fixed number, for example, 6, and after the number of captured rooms reaches the fixed number, the user cannot add rooms.

In another implementation, there is no upper limit for the number of capturable rooms, and the user may continuously add rooms according to his/her own needs. Optionally, the room capture interface further includes a room adding option; and in response to a selection operation by the user on the room adding option, a capturable room is added to the target space, and the user may modify the name of the newly added capturable room.

When the user opens the capture function for the first time, all capturable rooms of the target space are not captured, and at this time, the uncaptured rooms of the target space includes all capturable rooms of the target space. After the user completes the capture of a part of rooms, the uncaptured rooms of the target space are remaining uncaptured rooms.

The information of the uncaptured rooms includes names or serial numbers of the uncaptured rooms, and optionally, may further include at least one of operation options of the uncaptured rooms and icons of the uncaptured rooms, and icons of different types of rooms are different.

The names or serial numbers of the rooms are used for the user to distinguish different rooms, and the names of the rooms usually have semantics, for example, the target space is “My Home”, and the names of the rooms in the target space may be “Living Room”, “Master Bedroom”, “Guest Bedroom”, “Study”, “Kitchen”, “Game Room”, and the like.

The operation option of the uncaptured room may be an operation area of the uncaptured room, or may be an operation control of the uncaptured room.

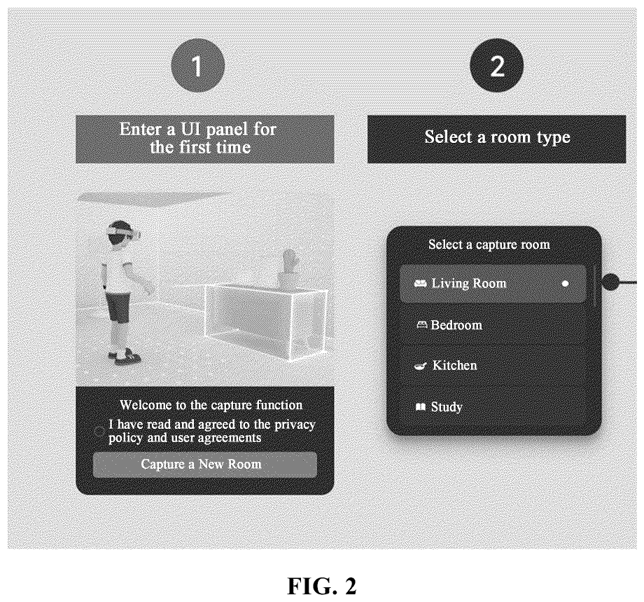

FIG. 2 is a schematic diagram of a UI after the user opens a room capture function for the first time, as shown in FIG. 2, a user interface on a left side is displayed when the user opens the room capture function for the first time, after the user clicks on a “Capture a New Space” control for the first time, a room capture interface shown on a right side is opened, the room capture interface includes the information of four uncaptured rooms, and the user selects one of the uncaptured rooms for capture.

When the user opens the room capture function for the first time, the user interface on the left side of FIG. 2 is displayed, optionally, when the user does not open the room capture function for the first time, the user interface on the left side may not be displayed, but the room capture interface is directly displayed for the user to select a room to be captured.

Optionally, the room capture interface may further include information of captured rooms, and when the information of the uncaptured rooms and the information of the captured rooms are simultaneously displayed in the space capture interface, the information of the uncaptured rooms and the information of the captured rooms are displayed in different manners, so that the user can distinguish which rooms have been captured and which rooms are not captured. For example, the information of the captured rooms is highlighted, and the information of the uncaptured rooms is normally displayed; or the information of the captured rooms includes a captured identifier, the information of the uncaptured rooms does not include the captured identifier or includes an uncaptured identifier, the captured identifier is different from the uncaptured identifier, and the captured identifier and the uncaptured identifier each includes, but is not limited to, a text, a pattern, or an icon.

In the present embodiment, one environmental map is created for the target space, the environmental map of the target space is a virtual space or virtual environment corresponding to a real environment where the target space is located, and the environmental map is obtained by performing the capture according to a VST function of the XR device. The environmental map has a unique identifier, which is referred to as a map ID. When the XR device captures a first room of the target space, the environmental map is created, or when the target space is created, the environmental map is created.

The environmental map may be considered as empty when it is just created, and with the capture of the rooms in the target space, the environmental map is continuously updated according to the capture result of the rooms, that is, the environmental map is continuously amplified, and the method in the present embodiment requires that the environmental map has an amplification function, or that the environmental map is an incremental map.

The association between the environmental map and anchors of a plurality of captured rooms may be understood as: establishing an association relationship or a correspondence or a binding relationship between the environmental map and the anchors of the plurality of captured rooms, and the association between the environmental map and the anchors of the plurality of captured rooms may also be described as that the environmental map is bound with the anchors of the plurality of captured rooms. Each room has an identifier, the identifier may uniquely distinguish one room inside the device, and the identifier of the room may be the same as or different from the name or serial number of the room. When the identifier of the room is different from the name or the serial number of the room, the identifier of the room has a correspondence with the name or serial number of the room, and the identifier of the room is used for distinguishing the room inside the device, and the name or serial number of the room is used for the user to distinguish the room.

For any captured room, the identifier of the captured room is used as an index of the anchor of the captured room, and anchor information of the captured room may be acquired according to the identifier of the captured room.

When displaying one environmental map, the XR device needs to display the environmental map according to environmental data and anchor information of the environmental map, the environmental data of the environmental map includes an environmental feature point, a key point and a key frame, and the environmental feature point is also referred to as point cloud data of the environment.

An anchor has a location and a direction (which may be understood as a posture), which are referred to as information of the anchor, the anchor is located in the environmental map, and the anchor is associated with the environmental map, that is, the anchor and the location of a feature point in the environmental map are fixed. An MR technology may associate one or more virtual objects for each anchor in the environmental map, and when the pose of the user changes, the virtual object associated with the anchor in the environmental map corresponding to the current pose of the user is called according to the pose of the user. For example, the association between the anchor and the virtual object includes displaying the virtual object on the location of the anchor, the pose of the virtual object is the information of the anchor, and when the pose of the user changes, the associated virtual object is displayed according to the pose of the anchor.

In the present embodiment, associating the environmental map with the anchors of the plurality of captured rooms in the target space is equivalent to dividing all anchors of the environmental map according to areas, one area is one room, and when the anchors of the environmental map are called, the anchors are called according to a room granularity.
S102: In response to a selection operation by the user on an uncaptured target room in the room capture interface, the target room is captured according to a multi-room capture policy.

The selection operation may be a click operation, a double-click operation, a long-press operation or a hover operation and the like of the user on the information of the target room, which is not limited in the present embodiment. For example, referring to FIG. 2, the user selects the “Living Room” as the target room.

Exemplarily, the multi-room capture policy includes: closed spaces of any two captured rooms of the environmental map do not overlap with each other. A plurality of capture planes in a room form a closed space, a plurality of capture lines in the room are connected to form a plurality of capture planes, and the capture planes are connected to form a closed space. For example, taking a wall as an example, four capture lines of the wall are usually connected to form the capture plane of the wall, and the capture planes of the walls in a space are connected to form a closed space.

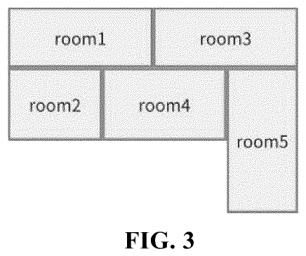

FIG. 3 is a schematic diagram of a captured room of the target space, FIG. 3 is a top view of the closed space of the captured room, as shown in FIG. 3, there are five rooms in the target space, and the closed spaces of the five rooms do not overlap each other.

When a first room in the target space is captured, there is no captured room, thereof the capture of the first room is not limited by the above capture policy. When other rooms (i.e., non-first capture rooms) in the target space are captured, since there is a captured room, the capture of the other rooms is limited by the above capture policy.

The target room may be captured in a full-automatic capture manner, a semi-automatic capture manner or a full-manual capture manner. The full-automatic capture manner requires no operation by the user, a part of capture objects in the semi-automatic capture manner requires the assistant manual labeling by the user, and all capture objects needs to be manually captured by the user in the full-manual capture manner.

In one implementation, an image corresponding to the target room is acquired, and the target room is captured in the order of a floor, a wall space, a ceiling and furniture according to the image corresponding to the target room. The closed space of the target room is formed by connecting capture lines of the floor, the wall space and the ceiling of the target room. When the closed space of the target room is captured, in response to detecting that a target capture line of the closed space of the target room overlaps with the closed space of a captured room of the environmental map, first prompt information is output. The first prompt information is used for prompting a location error of the target capture line, and/or prompting to adjust the location of the target capture line to a correct location.

The user may adjust the location of the target capture line according to the first prompt information, and in a case where the target capture line still overlaps with the closed space of the captured room of the environmental map after multiple times of adjustment, a capture failure is prompted.

In the present embodiment, the anchors of the environmental map are called by using a room as the granularity, therefore the range of the room needs to be accurately captured and recognized, and thus it is limited that the closed spaces of any two captured rooms of the environmental map do not overlap with each other, thereby avoiding a case where the anchor of the room cannot be accurately loaded during a use process of the environmental map.

Assuming that the closed spaces of the two captured rooms have an overlapping area, when the user is located in the overlapping area, the XR device cannot determine which room the user is located currently, and thus cannot load the anchor of the room, or the XR device cannot accurately determine which room the user is located currently. For example, when the user moves from the room 1 to the room 2, the user expects to load the anchor of the room 2, but the XR device considers that the user still stays in the room 1 due to a determination error. By limiting that the closed spaces of any two captured rooms of the environmental map do not overlap with each other, the problem mentioned here may be avoided, and the room where the user is located currently may be accurately recognized.

In order to improve the capture efficiency, optionally, when the target room is captured, in addition to displaying a perspective image corresponding to the target room, a closed floor area or a closed space of the captured room in the target space may also be displayed. The closed floor area is a part of the closed space, that is, an area located on the floor of the closed space.

When the user captures the target room in the order of the floor, the wall space, the ceiling and the furniture, the location of a capture ray emitted from a handle may be determined with the displayed closed floor area or the closed space of the captured room in the target space as a reference, thereby avoiding the capture line of the target room intersecting the closed floor area or the closed space of the captured room in the target space, and thus the capture efficiency can be improved.

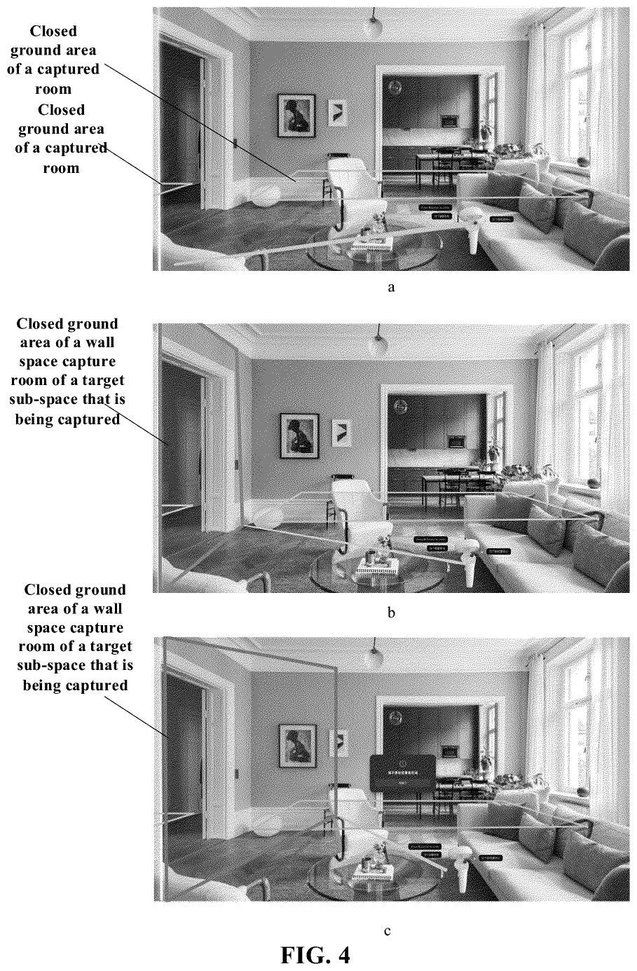

FIG. 4 is a schematic diagram of a location relationship between the closed floor area of the captured room in the target space and a wall space of the target room. As shown in FIG. 4, FIG. 4a is a schematic diagram of the closed floor areas of two captured spaces in the target space before the target room is captured, FIG. 4b illustrates a case where one wall space of the target room, which is being captured, does not intersect with the closed floor areas of two captured spaces, and FIG. 4c illustrates a case where the wall space of the target room intersects with the closed floor area of one captured space.

When capture objects in the target room are captured, a semitransparent mask layer is displayed on the capture plane of a captured object in the target room, and for the capture object that is being captured, a semitransparent mask layer is displayed on the capture plane synchronously according to the formation of the capture plane of the capture object that is being captured. The capture objects include a floor, a wall space, a ceiling and furniture. An uncaptured capture object in the target space is normally displayed, and the captured object is displayed in a semi-transparent manner, and the mask layer is equivalent to covering a layer of semitransparent mask on an outer surface of the captured object, so that the changed object seen by the user is partly hidden and partly visible.

By displaying the semitransparent mask layer on the capture object that has been captured, the user may conveniently distinguish which capture objects have been captured and which capture objects are not captured. For the capture object that is being captured, during the process of forming the capture plane, the mask layer is synchronously formed, that is, the mask layer and the capture plane are synchronously formed, so that the user can conveniently learn about the formation process and location of the capture plane in real time, thereby bringing better experience to the user.

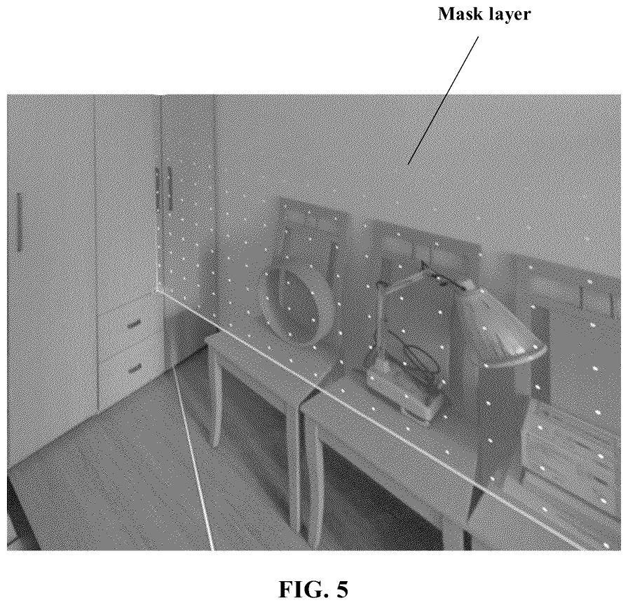

FIG. 5 is a schematic diagram of a mask layer of a captured wall space in the target room. As shown in FIG. 5, the user is capturing a wall space, and for the captured wall space, a mask layer is displayed on the capture plane thereof; and for uncaptured furniture, an uncaptured ceiling and the like in the target room, there is no mask layer on the outer surface thereof.

Optionally, in some implementations, the closed spaces of two captured rooms may overlap with each other, no anchor is set in the intersection area or the overlapping area, or anchors are set in the intersection area or the overlapping area, but the anchors set in the intersection area or the overlapping area are not loaded, or when the user is located in the overlapping area, the user is prompted to move, so that the user moves out of the overlapping area.

Optionally, the multi-room capture policy further includes: a capture box of furniture in a room cannot exceed the closed space of the room. The purpose of the capture policy is still to avoid that the XR device cannot accurately recognize the range of the room, and when the capture box of the furniture in the room exceeds the closed space of the room, the XR device cannot determine which room the furniture belongs. Therefore when the anchor of the room is loaded, the anchor of the room may be loaded incorrectly, for example, an anchor on the furniture exceeding the closed space of the room is not loaded.

In one implementation, the image corresponding to the target room is acquired, and the target room is captured in the order of the floor, the wall space, the ceiling and the furniture according to the image corresponding to the target room. The closed space of the target room is formed by connecting the capture lines of the floor, the wall space and the ceiling of the target room. In response to detecting that the capture box of target furniture in the target room exceeds the closed space of the target room, second prompt information is output. The second prompt information is used for prompting a capture error of the target furniture, and/or prompting to adjust the capture box of the target furniture.

The user may adjust the capture box of the target furniture according to the second prompt information, and in a case where the target furniture still exceeds the closed space of the room after multiple times of adjustment, a capture failure is prompted.
S103: Environmental data of the environmental map is updated according to a capture result of the target room, and the anchor of the target room is associated with the environmental map.

The capture result of the target room may include location information of the floor, the wall space, the ceiling, the furniture and the like in the room, and the location information may be 3D coordinates of the floor, the wall space, the ceiling and the furniture. The environmental data of the environmental map is updated according to the capture result of the target room, and when the data of the environmental map changes, the environmental map displayed to the user also changes.

Updating the environmental data of the environmental map according to the capture result of the target room includes: generating environmental data of the target room according to the capture result of the target room, and adding the environmental data of the target room into the environmental data of the environmental map, so that the environmental map is expanded, and the updated environmental map includes the target room. In one optional manner, the capture result of the target room is the environmental data of the target room, and in another optional manner, the capture result of the target room is processed to obtain the environmental data of the target room.

Exemplarily, the anchor of the target room is associated with the environmental map in the following manner: generating anchor information of the target room, and storing the anchor information of the target room by using an identifier of the target room as an index; and establishing an association relationship between the identifier of the target room and an identifier of the environmental map.

The environmental data of the environmental map and the anchor information of the captured room may be stored in a magnetic disk of the XR device, and may also be stored in the cloud. When the anchor information of the captured room is stored, the anchor information of the captured room is stored by using the identifier of the captured room as the index, and the anchor information of the captured room may be subsequently queried according to the identifier of the captured room.

Different from the prior art, in the present embodiment, it is also necessary to store an association relationship between the identifier of the environmental map and the identifier of the captured room, and the identifier of the environmental map is associated with the identifiers of a plurality of captured rooms. Establishing the association relationship between the identifier of the target room and the identifier of the environmental map may include: adding the identifier of the target room on the basis of the existing association relationship between the identifier of the environmental map and the identifiers of the plurality of captured rooms.

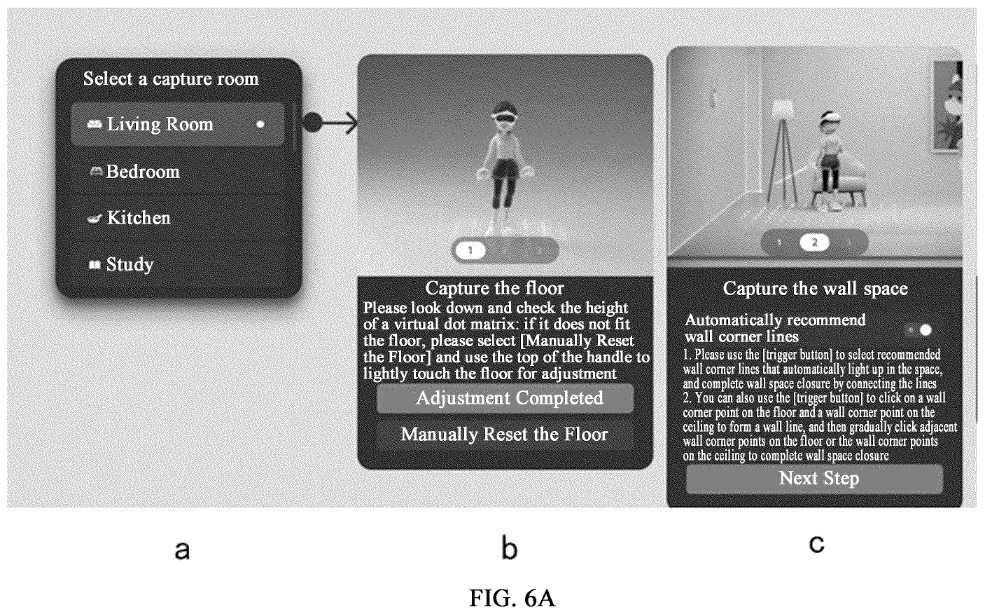

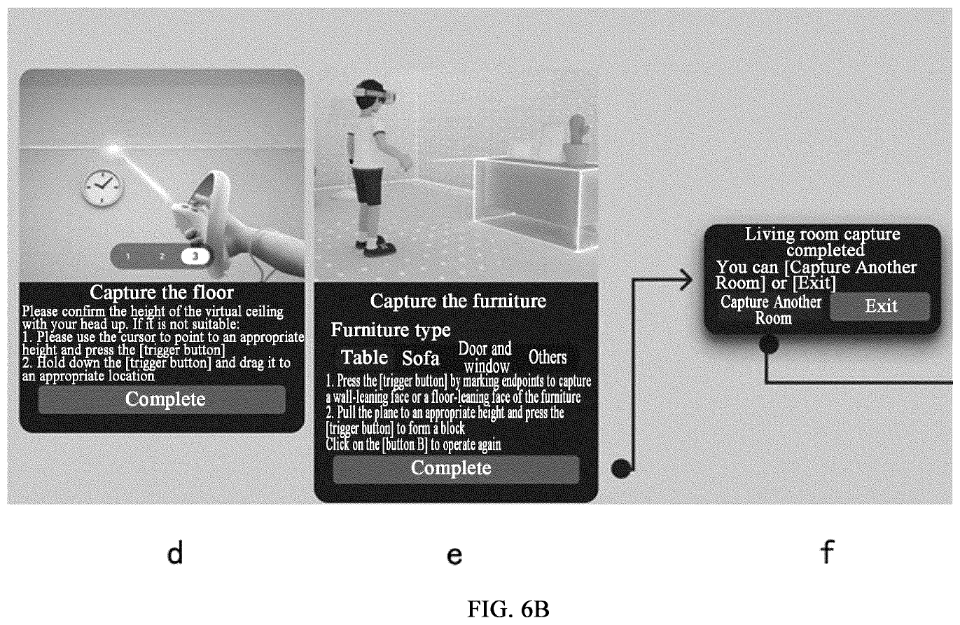

FIGS. 6A and 6B are a schematic diagram of a change of the UI during a room capture process, as shown in FIGS. 6A and 6B, after opening the room capture function, the user selects to capture a room, UIa is displayed, that is, the room capture interface, then the user selects a room to be captured, and then sequentially captures a floor, a wall space, a ceiling and furniture. A part of the UIs displayed during the capture process of the floor, the wall space, the ceiling and the furniture are respectively: UIb, UIc, UId and UIe. After the capture of the furniture is completed, the room capture flow is ended, after the user clicks on a complete control in the UIe, Ulf is displayed. If the user selects an exit control in the UIf, the capture flow is ended, and the room capture function is exited. If the user selects a “Capture Another Room” control in the Ulf, the room capture interface is displayed, and the next room continues to be captured according to the above flow.

After the anchor of the target room is associated with the environmental map, the capture of the target room is completed, the MR application may perform MR content according to the environmental map and the anchors of the plurality of rooms associated with the environmental map, and some new MR functions may also be developed, for example, the user may see different content after entering different rooms.

The method in the present embodiment includes: displaying a room capture interface in response to a room capture trigger instruction, the room capture interface including information of uncaptured rooms of a target space, and an environmental map of the target space being associable with anchors of a plurality of captured rooms in the target space; capturing, according to a multi-room capture policy, a target room selected by a user; and updating environmental data of the environmental map according to a capture result of the target room, and associating the anchor of the target room with the environmental map. In the method, one environmental map is created for a plurality of rooms in a target space; with the capture of the rooms in the target space, the environmental map is continuously increased; and the environmental map is associable with the anchors of a plurality of captured rooms in the target space. During the use process of the MR application, only once positioning needs to be performed on the environmental map; and when the user moves between different rooms, it is not necessary to reposition the environmental map, and it only needs to switch the anchors of the rooms. In addition, according to a multi-room capture result, richer functions or game plays may be provided for the MR application, thereby improving the user experience.

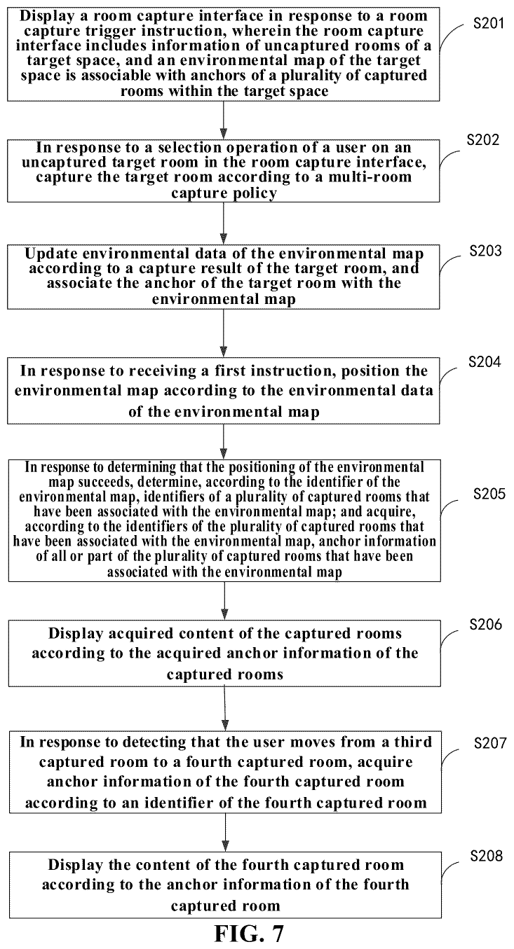

Based on Embodiment 1, Embodiment 2 of the present application provides a multi-room capture method, which mainly describes an application of the multi-room capture result, FIG. 7 is a flowchart of a multi-room capture method provided in Embodiment 2 of the present application, and as shown in FIG. 7, the method provided in the present embodiment includes the following steps.
S201: A room capture interface is displayed in response to a room capture trigger instruction, the room capture interface includes information of uncaptured rooms of a target space, and an environmental map of the target space is associable with anchors of a plurality of captured rooms in the target space.
S202: In response to a selection operation by a user on an uncaptured target room in the room capture interface, the target room is captured according to a multi-room capture policy.
S203: Environmental data of the environmental map is updated according to a capture result of the target room, and the anchor of the target room is associated with the environmental map.

For specific implementations of steps S201 to S203, reference may be made to Embodiment 1, and thus details are not described herein again.
S204: In response to receiving a first instruction, the environmental map is positioned according to the environmental data of the environmental map.

The first instruction includes, but is not limited to, an opening instruction of the MR application, and the first instruction is used for triggering the positioning of the environmental map. The XR device positions the environmental map according to a feature point of a current real environment, which is photographed by a camera, and the environmental data of the environmental map of the target space. If the feature point of the current real environment matches the environmental data of the environmental map, the positioning of the environmental map succeeds. If the feature point of the current reality environment does not match the environmental data of the environmental map, the positioning of the environmental map fails. The XR device may include a plurality of environmental maps, different environmental maps have different identifiers, map data of the environmental maps is loaded into a memory from a magnetic disk in sequence according to the identifiers of the environmental maps, and then the environmental maps are positioned until the positioning succeeds.
S205: When the positioning of the environmental map succeeds, identifiers of a plurality of captured rooms that have been associated with the environmental map are determined according to the identifier of the environmental map; and anchor information of all or part of the plurality of captured rooms that have been associated with the environmental map is acquired according to the identifiers of the plurality of captured rooms that have been associated with the environmental map.

After the environmental map is retrieved, anchor information corresponding to the environmental map needs to be loaded into the memory. In the present embodiment, the identifiers of the captured rooms associated with the environmental map is determined according to the identifier of the successfully positioned environmental map and a stored association relationship between the identifier of the environmental map and the identifiers of the captured rooms, and the anchor information of the captured rooms is loaded into the memory according to the identifiers of the captured rooms associated with the environmental map. Loading the anchor information of the captured rooms into the memory refers to loading the anchor information from a magnetic disk or hard disk of the XR device or another storage device into the memory.

In the present embodiment, the anchor information of all or part of the plurality of captured rooms may be loaded according to the requirements of the MR application. In some applications, only the anchor of the room where the user is located currently may be loaded, that is, anchor loading is performed depending on user positioning. In some other applications, the anchor information of all rooms may be loaded, and anchor loading is no longer performed depending on user positioning.

Exemplarily, an identifier of a second captured room to be loaded is determined according to a loading rule, and the anchor information of the second captured room is loaded into the memory according to the identifier of the second captured room. The loading rule is configured in the XR device, for example, the loading rule is configured to load the anchors of all rooms, or the loading rule is configured to load the anchors of three rooms.
S206: Acquired content of the captured rooms is displayed according to the acquired anchor information of the captured rooms.

The content of all or part of loaded rooms in the memory may be displayed. Exemplarily, an identifier of a first captured room to be displayed is determined according to a display rule; an anchor of the captured room to be displayed is determined from the memory according to the identifier of the first captured room; and the content of the first captured room is displayed according to the anchor information of the first captured room. Or, all rooms in the memory are displayed by default, or the room where the user is located currently is displayed by default.
S207: In response to detecting that the user moves from a third captured room to a fourth captured room, anchor information of the fourth captured room is acquired according to an identifier of the fourth captured room.

According to the method in the present embodiment, the room where the user is located currently can be positioned, and the switching of the room can be detected. When the user moves from the third captured room to the fourth captured room, the movement of the user can be detected; and the room where the user is located currently is positioned as the fourth captured room, the identifier of the fourth captured room is acquired, and the third and the fourth are only intended to distinguish the rooms before and after the movement.

In response to detecting that the user moves from the third captured room to the fourth captured room, the anchor information of the fourth captured room is acquired according to the identifier of the fourth captured room. Specifically, whether the anchor information of the fourth captured room is present in the memory is determined according to the fourth captured room. In a case where the anchor information of the fourth captured room is not loaded in the memory, the anchor information of the fourth captured room is loaded from the magnetic disk into the memory. In a case where the anchor information of the fourth captured room has been loaded into the memory, the anchor of the captured room to be displayed is determined from the memory according to the identifier of the fourth captured room.
S208: The content of the fourth captured room is displayed according to the anchor information of the fourth captured room.

Optionally, in response to detecting that the user moves from the third captured room to the fourth captured room, the content of the third captured room may also be closed at first, and then the content of the fourth captured room is displayed, so as to switch from the content of the third captured room to the content of the fourth captured room.

When the user moves from the third captured room to the fourth captured room, it is not necessary to perform map positioning, the environmental map of the target space is still used, and it is only necessary to switch from the anchor of the third captured room to the anchor of the fourth captured room, so as to implement seamless switching between rooms.

According to the multi-room capture result, richer functions or game plays may be provided for the MR application, for example, different dress ups or themes are set for different rooms, and when moving to different rooms, the user may see different dress ups or experience different themes.

As another example, an auxiliary MR application manages mounted applications, and different applications may be mounted in different rooms. For example, a video application is mounted on a wall of the room 1, a game application is mounted on a television of the room 2; when the user moves into the room 1, the video application is opened, and after the user moves from the room 1 to the room 2, the game application in the room 2 is opened. Optionally, the video application in the room 1 may be also be closed at first, and then the game application in the room 2 is opened.

As another example, the content of any one or more rooms in the captured rooms associated with the environmental map is displayed to the user independent of the location of the user.

It can be understood that more functions may be developed based on multi-room capture, which is merely an example and does not constitute a limitation.

It should be noted that steps S207 and S208 are optional steps, during the use process of the MR application, the user may move to different rooms or not move, and when the user does not move between the rooms, steps S207 and S208 are not executed.

Optionally, when the content of the fourth captured room is displayed according to the anchor information of the fourth captured room, a semi-transparent mask layer is displayed on a capture plane of a captured object in the fourth captured room. The user can know whether the currently located room has been captured according to the mask layer, which articles in the currently located room have been captured, and which articles are not captured. In a case where the capture of some captured objects is inaccurate, the captured objects may be deleted for recapture, or for the uncaptured objects, the capture mode may be opened for recapture.

When the user moves from the third captured room to the fourth captured room, the content of the third captured room may be closed. When the content of the third captured room is closed, the mask layer of the third captured room is closed at the same time. Or, the content of the third captured room continues to be displayed, and the mask layer of the third captured room is closed, so that the when the user enters which room, the mask layer of the room is opened.

In the present embodiment, after the MR application is opened, the environmental map is positioned according to the environmental data of the environmental map. When the positioning of the environmental map succeeds, the anchor information of all or part of the plurality of captured rooms that have been associated with the environmental map is loaded into the memory according to the identifiers of the plurality of captured rooms that have been associated with the environmental map. The content of the loaded captured room in the memory is displayed according to the anchor information of the loaded captured room in the memory. The anchors of the rooms may be called according to the identifiers of the rooms, so that different functions can be set for different rooms, and the user can experience different content after entering different rooms. When the user switches between different rooms, it is not necessary to reposition the environmental map, and it only needs to switch the anchors of different rooms, thereby improving the user experience.

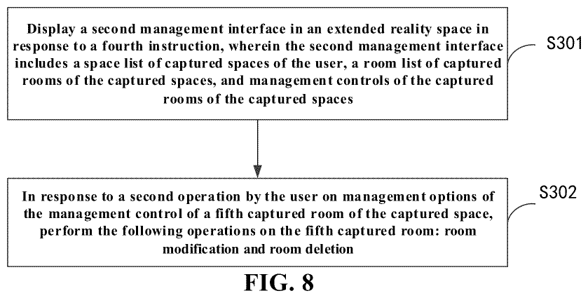

Based on Embodiment 1 and Embodiment 2, Embodiment 3 of the present application further provides a multi-room capture method, which is used for managing captured rooms in the target space. FIG. 8 is a flowchart of a multi-room capture method provided in Embodiment 3 of the present application, and as shown in FIG. 8, the method provided in the present embodiment includes the following steps.
S301: A second management interface is displayed in an extended reality space in response to a fourth instruction, the second management interface includes a space list of captured spaces of the user, a room list of captured rooms of the captured spaces, and management controls of the captured rooms of the captured spaces.

The user may open the second management interface via a space management entry of the MR application, one user may have a plurality of captured spaces, and each captured space may have one or more captured rooms. The room list of the captured rooms of the captured spaces may be displayed in the form of a secondary menu. For example, after the user opens the second management interface, only the space list of the captured spaces of the user is displayed, and when the user clicks on any captured space in the space list of the captured spaces, the room list of captured rooms of the selected captured space and the management controls of the captured rooms of the captured space are displayed. Similarly, the management controls of the captured rooms of the captured spaces may be displayed in the form of a three-level menu, and details are not described herein again.

The user may open the second management page in any scene after the MR application is opened, for example, before capturing the target space, during the process of capturing the target space, or after capturing the target space. The extended reality space is a virtual space provided by the XR device, and is a 3D space, and the second management interface is usually a 2D display panel. When the user opens the second management interface before capturing the target space, the extended reality space may be a 3D desktop environment. When the user opens the second management interface during the process of capturing the target space, the extended reality space may be a perspective image of a room that is being captured; and when the user opens the second management interface after capturing the target space, the extended reality space may be a perspective image of a room where the user is located currently.
S302: in response to a second operation by the user on management options of a management control of a fifth captured room of the captured space, performing the following operations on the fifth captured room: room modification and room deletion.

Optionally, the management control of the captured room includes a deletion control and a modification control of the captured room. The user may select the deletion control or the modification control of the fifth captured room via the second operation. When the user selects the deletion control, the capture result of the fifth captured room is deleted. After the fifth captured room is deleted, the environmental data of the fifth captured room in the environmental data of the environmental map is also deleted. When the user selects the modification control, the capture result of the fifth captured room is modified.

Exemplarily, the room modification includes one or more of the following modification operations: modifying a name of the room, resetting a space capture result of the room, adding furniture in the room, deleting the furniture in the room, or modifying the anchor in the room. Resetting the space capture result of the room refers to resetting or recapturing the capture results of the floor, the wall space and the ceiling of the room. Modifying the anchor in the room includes adding a new anchor, deleting the anchor, modifying the location of the anchor, and the like.

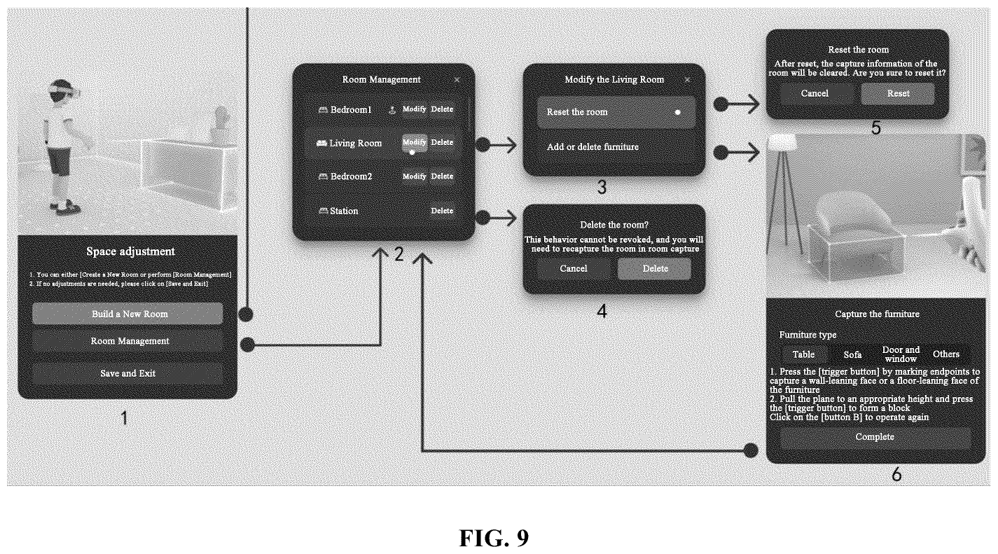

FIG. 9 is a schematic diagram of the UI involved in a management flow of a captured room. As shown in FIG. 9, when the user opens the multi-room capture function for the non-first time, UI1 is displayed. The room capture interface is displayed after the user selects a “Create a New Room” control. UI2, that is, the second management interface, is displayed after the user selects a “Room Management” control. UI3 is displayed in a case where the user selects to modify a certain room. UI4 is displayed in a case where the user selects to delete a certain room. In the UI3, UI5 is displayed in a case where the user selects to reset the room (i.e., reset the space capture result of the room). UI6 is displayed in a case where the user selects to add or delete the furniture. After modifying the room, the user may open UI2 to continue to delete or modify another room.

Optionally, the second management interface further includes a room adding control. A capturable room is added to the target space upon detecting a third operation by the user on the room adding control, and the newly added capturable room is captured according to the flow of the above embodiments, so that rooms can be flexibly added to the target space.

According to the embodiment in the present embodiment, the second management interface is displayed according to the fourth instruction, and the second management interface includes the space list of the captured spaces of the user, the room list of the captured rooms of the captured spaces, and the management controls of the captured rooms of the captured spaces. The following operations are performed on the fifth captured room according to the second operation by the user on the management options of the management control of the fifth captured room of the captured space: room modification and room deletion. By providing a room management function, the captured room can be flexibly deleted or modified, and the deletion of one room in the target space has no influence on the use of other rooms.

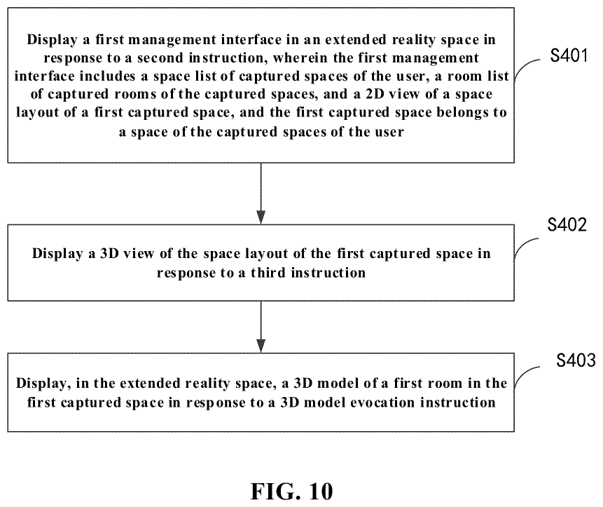

Based on Embodiment 1 and Embodiment 2, Embodiment 4 of the present application further provides a multi-room capture method, which is used for managing the captured rooms in the target space. FIG. 10 is a flowchart of a multi-room capture method provided in Embodiment 4 of the present application, and as shown in FIG. 10, the method provided in the present embodiment includes the following steps.
S401: A first management interface is displayed in an extended reality space in response to a second instruction, the first management interface includes a space list of captured spaces of the user, a room list of captured rooms of the captured spaces, and a 2D view of a space layout of a first captured space, and the first captured space belongs to a space of the captured spaces of the user.

The user may open the first management page in any scene after the MR application is opened. For example, before capturing the target space, during the process of capturing the target space, or after capturing the target space. The extended reality space is a virtual space provided by the XR device, and is a 3D space, and the first management interface is usually a 2D display panel. When the user opens the first management interface before capturing the target space, the extended reality space may be a 3D desktop environment. When the user opens the first management interface during the process of capturing the target space, the extended reality space may be a perspective image of a room that is being captured; and when the user opens the first management interface after capturing the target space, the extended reality space may be a perspective image of a room where the user is located currently.

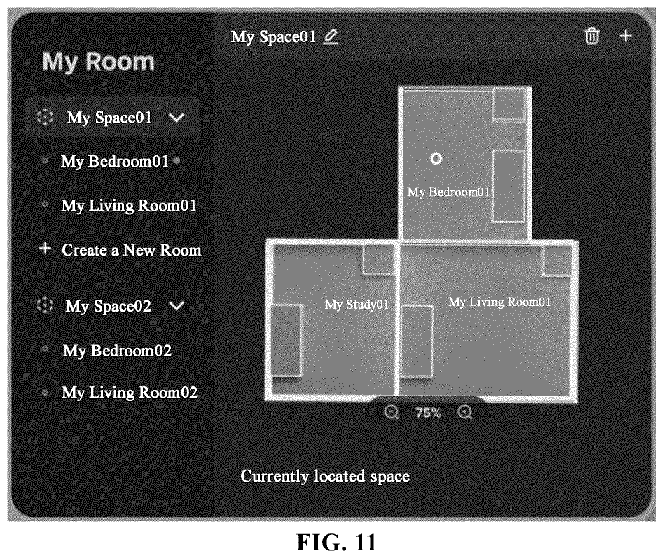

FIG. 11 is one schematic diagram of the first management interface. As shown in FIG. 11, the first management interface employs a left-right structure, the space list of the captured spaces of the user (hereinafter referred to as a space list) and the room list of the captured rooms of the captured spaces (hereinafter referred to as a room list) are displayed on a left side of the first management interface, and the 2D view of the space layout of the first captured space is displayed on a right side of the first management interface.

FIG. 12 is another schematic diagram of the first management interface. As shown in FIG. 12, the first management interface employs an upper-lower structure, the space list and the room list are displayed at the bottom of the first management interface, and the 2D view of the space layout of the first captured space is displayed above the space list and the room list.

The first captured space is any space in the captured spaces of the user, the first captured space may be a space where the user is located currently or not, and the user may select one captured space from a plurality of captured spaces.

The 2D view of the space layout of the first captured space may be a partial top view of the space, and the user may clearly learn about the layout of a room in the first captured space via the 2D view, including a location relationship of the room, a size relationship of the room, etc.

When the first captured space is the space where the user is located currently, an identifier of the current location of the user is further displayed in the 2D view. For example, “My Bedroom 01” shown in FIG. 11 and FIG. 12 is the current location of the user, a circle in the “My Bedroom 01” is the identifier of the current location, and it can be understood that the identifier of the current location may also be represented by other icons and/or characters.
S402: A 3D view of the space layout of the first captured space is displayed in response to a third instruction.

The 3D view of the space layout of the first captured space may be displayed on the first management interface, and may also be displayed by a separate third interface, and both the third interface and the first management interface are 2D panels, which are displayed in the extended reality space provided by the XR device at the same time.

When the 3D view is displayed on the first management interface, the 3D view may be displayed at arbitrary upper, lower, left and right locations of the 2D view of the space layout of the first captured space, or the 2D view is hidden and only the 3D view is displayed.

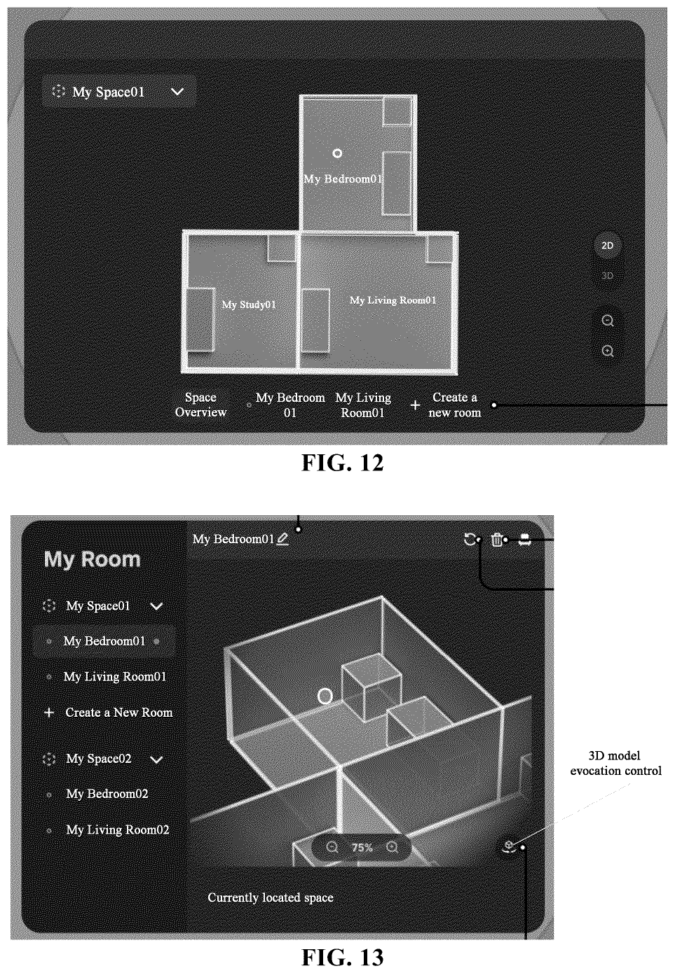

FIG. 13 is one schematic diagram of the 3D view of the space layout of the first captured space displayed in the first management interface, and FIG. 13 is obtained by transforming the interface shown in FIG. 11. FIG. 14 is another schematic diagram of the 3D view of the space layout of the first captured space displayed in the first management interface, and FIG. 14 is obtained by transforming the interface shown in FIG. 12.

A zoom-in control and a zoom-out control are further displayed on the first management interface shown in FIG. 13 and FIG. 14, the user zooms in the 3D view via the zoom-in control, and zooms out the 3D view via the zoom-out control.

Exemplarily, an opening control of the 3D view is displayed at the location of each room on the 2D view, and the 3D view is displayed on the first management interface upon detecting a preset operation by the user on the opening control of the 3D view, so that the user can conveniently check the 3D view of each room. Or, the user may open the 3D view by performing a double-click, a click, a hover operation and the like on any location in the 2D view.

Or, a 2D control and a 3D control are further displayed on the interface shown in FIG. 12 and FIG. 14, and flexible switching between the 2D view and the 3D view of the space layout of the first captured space is implemented by the 2D control and the 3D control.

Optionally, in one implementation, when the user initially opens the first management interface, the 2D view of the space layout of the first captured space is displayed on the first management interface, and in response to detecting that the user moves from a first room to a second room in the first captured space, the 3D view of the space layout of the first captured space is displayed on the first management interface.

When the user moves in a plurality of rooms of the captured space, the first management interface may move along with the user, and is always located within the angle of view of the user. For example, the user opens the first management interface in the first room, and after the user moves to the second room, the first management interface moves to the second room along with the user.

Referring to FIG. 13 and FIG. 14, three controls are displayed at a top right corner of the first management interface, which are respectively controls corresponding to room reset, room deletion and furniture modification. The room reset control is used for resetting the space capture result of the room, the room deletion control is used for deleting the whole room, and one sub-interface may be opened by the furniture modification control to add or delete the furniture in the room in the sub-interface.

A name modification control is displayed at the top right corner of the first management interface as shown in FIG. 13, the user modifies the name of the currently displayed first captured space by the name modification control. Although the name modification control is not shown in FIG. 14, it can be understood that the name modification control may also be set on the first management interface as required.
S403: A 3D model of the first room in the first captured space is displayed in the extended reality space in response to a 3D model evocation instruction.

The 3D model of the first room may be understood as a sand table model of the first room, and is a model obtained according to a real proportion of the layout of the first room.

To bring an immersive experience to the user, the first management interface may be hidden at first, and the model of the first room is displayed.

Optionally, a 3D model evocation control is displayed on the 3D view of the space layout of the first captured space or the first management interface. As shown in FIG. 13 and FIG. 14, when a preset operation on the 3D model evocation control is detected, the 3D model of the first room in the first captured space is displayed in the extended reality space. The first room may be a room selected by the user or a room where the user is located currently.

When the first captured space is the space where the user is located currently, and the first room is the room where the user is located currently. At this time, the extended reality space is a perspective image corresponding to the first room. In response to the evocation instruction, not only the first management interface is hidden, but the mask layer of the first room is also opened, so that the user can experience the 3D model of the first room in an immersive manner.

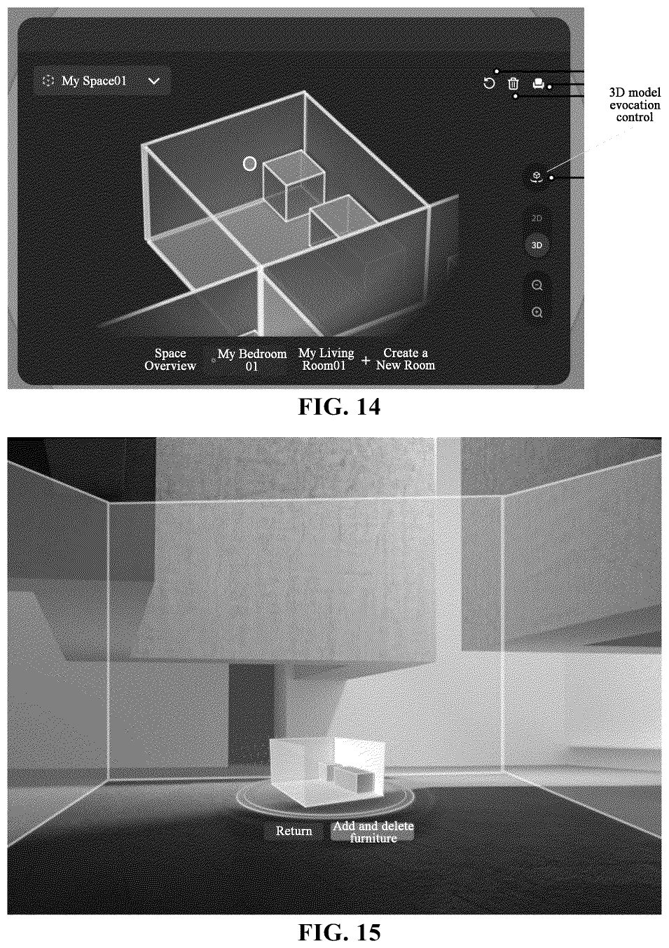

FIG. 15 is a schematic display diagram of a 3D model of a room, and as shown in FIG. 15, the 3D model of the first room is displayed in a perspective image of the first room.

Upon detecting first operation, the 3D model of the first room is controlled to enter an editing state, and the 3D model of the first room displays a preset effect after the 3D model of the first room enters the editing state. Upon detecting a second operation, the 3D model of the first room is controlled to rotate.

The first operation is, for example, a hover operation on an area where the 3D model is located, the preset effect is, for example, the bottom of the 3D model is highlighted, or an aperture effect is displayed at the bottom of the 3D model, as shown in FIG. 15.

After the 3D model enters the editing state, the user may rotate the 3D model via the second operation, and the second operation may be a press operation on a trigger button for the navigation of the handle or a press operation on a direction button of the handle. By the second operation, the 3D model of the first room may be controlled to rotate in the horizontal direction, or to rotate by 360 degrees in the extended reality space. By controlling the 3D model to rotate, it is convenient for the user to view and learn about the layout of the first room.

Optionally, after the 3D model enters the editing state, a furniture addition and deletion control and a return control are further displayed in an extended control, the return control is used for exiting the display of the 3D model, and the furniture addition and deletion control is used for adding or deleting the furniture in the first room.

When the first captured space is the space where the user is located currently, and the first room is the room where the user is located currently, in response to detecting that a rotation angle of a head-mounted device is greater than a preset angle or the 3D model of the first room exceeds the field of view of the user, the 3D model of the first room is controlled, according to the current location of the user, to move to a preset location in the field of view of the user.

The preset angle is, for example, 30 degrees, the user wears the head mount device to move or rotate, when the rotation angle of the head mount device is greater than 30 degrees, the 3D model of the first room is no longer located directly in front of the field of view of the user, and may be removed from or located at the edge of the field of view of the user. At this time, the 3D model of the first room is controlled to move to the preset location in the field of view of the user, and the preset location may be directly in front of the field of view, thereby facilitating the user to view the 3D model.

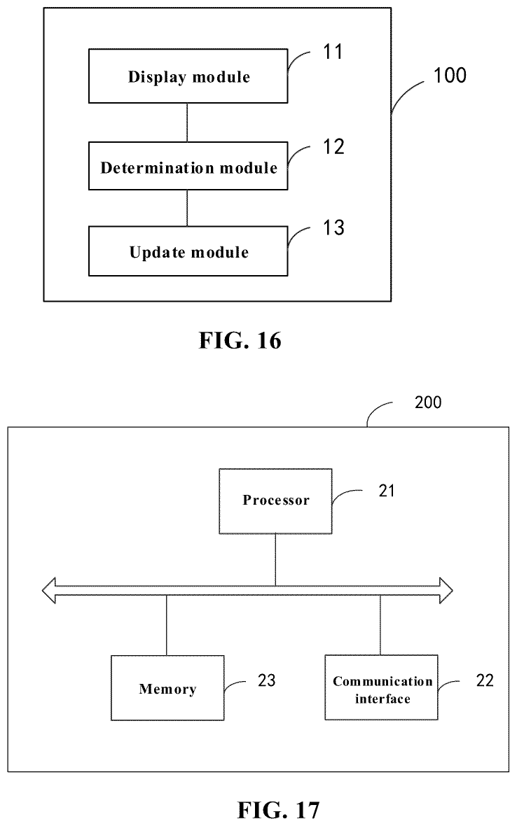

To better implement the multi-room capture method in the embodiments of the present application, an embodiment of the present application further provides a multi-room capture apparatus. FIG. 16 is a schematic structural diagram of a multi-room capture apparatus provided in Embodiment 5 of the present application, and as shown in FIG. 16, the multi-room capture apparatus 100 may include: a display module 11, a capture module 12 and an update module 13.

The display module 11 is configured to display a room capture interface in response to a room capture trigger instruction, wherein the room capture interface includes information of uncaptured rooms of a target space, and an environmental map of the target space is associable with anchors of a plurality of captured rooms within the target space.

The capture module 12 is configured to: in response to a selection operation by a user on an uncaptured target room in the room capture interface, capture the target room according to a multi-room capture policy.

The update module 13 is configured to update environmental data of the environmental map according to a capture result of the target room, and associate an anchor of the target room with the environmental map.

In some embodiments, the multi-room capture policy includes that: closed spaces of any two captured rooms of the environmental map do not overlap with each other.

In some embodiments, the multi-room capture policy further includes that: a capture box of furniture within a room does not exceed the closed space of the room.

In some embodiments, the capture module 12 is specifically configured to: acquire an image corresponding to the target room, and capture, according to the image corresponding to the target room, the target room in the order of a floor, a wall space, a ceiling and furniture, wherein the closed space of the target room is formed by connecting capture lines of the floor, the wall space and the ceiling of the target room; capture the closed space of the target room; and in response to detecting that a target capture line of the closed space of the target room overlaps with the closed space of a captured room of the environmental map, output first prompt information, wherein the first prompt information is used for prompting a location error of the target capture line, and/or prompting to adjust the location of the target capture line to a corrected location.

In some embodiments, the capture module 12 is specifically configured to: determine, according to the image corresponding to the target room, a perspective image corresponding to the target room; display the perspective image corresponding to the target room and a closed floor area or a closed space of the captured room within the target space; and capture the target room in the order of the floor, the wall space, the ceiling and the furniture.

In some embodiments, the capture module 12 is specifically configured to: capture a capture object within the target room, synchronously display a semitransparent mask layer on a capture plane according to the formation of the capture plane of the capture object that is being captured, wherein a semitransparent mask layer is displayed on a capture plane of a captured object within the target room.

In some embodiments, the capture module 12 is specifically configured to: acquire the image corresponding to the target room, and capture, according to the image corresponding to the target room, the target room in the order of the floor, the wall space, the ceiling and the furniture, wherein the closed space of the target room is formed by connecting the capture lines of the floor, the wall space and the ceiling of the target room; and in response to detecting that the capture box of target furniture within the target room exceeds the closed space of the target room, output second prompt information, wherein the second prompt information is used for prompting a capture error of the target furniture, and/or prompting to adjust the capture box of the target furniture.

In some embodiments, the update module 13 is specifically configured to: generate anchor information of the target room, and store the anchor information of the target room by using an identifier of the target room as an index; and establish an association relationship between the identifier of the target room and an identifier of the environmental map.

In some embodiments, the apparatus further includes: a call module, configured to: in response to receiving a first instruction, position the environmental map according to the environmental data of the environmental map; in response to determining that the positioning of the environmental map succeeds, determine, according to the identifier of the environmental map, identifiers of a plurality of captured rooms that have been associated with the environmental map; according to the identifiers of the plurality of captured rooms that have been associated with the environmental map, acquire anchor information of all or part of the plurality of captured rooms that have been associated with the environmental map; and display acquired content of the captured rooms according to the acquired anchor information of the captured rooms.

In some embodiments, the call module is specifically configured to: determine, according to a loading rule and from the identifiers of the plurality of captured rooms that have been associated with the environmental map, an identifier of a second captured room to be loaded; and load the anchor information of the second captured room into a memory according to the identifier of the second captured room.

In some embodiments, the call module is specifically configured to: determine, according to a display rule, an identifier of a first captured room to be displayed; determine, according to the identifier of the first captured room and from the memory, an anchor of the captured room to be displayed; and display the content of the first captured room according to the anchor information of the first captured room.

In some embodiments, the call module is further configured to: in response to detecting that the user moves from a third captured room to a fourth captured room, acquire anchor information of the fourth captured room according to an identifier of the fourth captured room; and display the content of the fourth captured room according to the anchor information of the fourth captured room.

In some embodiments, the call module is further configured to: in response to detecting that the user moves from the third captured room to the fourth captured room, close the content of the third captured room.

In some embodiments, the call module is specifically configured to: according to the anchor information of the fourth captured room, display the content of the fourth captured room, and display a semitransparent mask layer on a capture plane of a captured object in the fourth captured room.

In some embodiments, the call module is specifically configured to: close the content of the third captured room, or display the content of the third captured room, and close the mask layer of the third captured room.

In some embodiments, the apparatus further includes a management module, configured to: display a first management interface in an extended reality space in response to a second instruction, wherein the first management interface includes a space list of captured spaces of the user, a room list of captured rooms of the captured spaces, and a 2D view of a space layout of a first captured space, and the first captured space belongs to a space of the captured spaces of the user.

In some embodiments, the management module is further configured to:
display a 3D view of the space layout of the first captured space in the extended reality space in response to a third instruction.

In some embodiments, the first captured space is a space where the user is located currently, and an identifier of a current location of the user is further displayed in the 2D view of the space layout of the first captured space; and the management module is specifically configured to: display the 3D view of the space layout of the first captured space in the first management interface in response to detecting that the user moves from a first room to a second room in the first captured space.

In some embodiments, the management module is further configured to: display, in the extended reality space, a 3D model of the first room in the first captured space in response to a 3D model evocation instruction.

In some embodiments, the management module is specifically configured to: hide the first management interface in the extended reality space, and display the 3D model of the first room.

In some embodiments, the management module is further configured to: upon detecting a first operation, control the 3D model of the first room to enter an editing state, wherein the 3D model of the first room is displayed with a preset effect after the 3D model of the first room enters the editing state; and upon detecting a second operation, control the 3D model of the first room to rotate.

In some embodiments, the first captured space is a space where the user is located currently, the first room is a room where the user is located currently, and the management module is further configured to: in response to detecting that a rotation angle of a head-mounted device is greater than a preset angle or the 3D model of the first room exceeds the field of view of the user, control, according to the current location of the user, the 3D model of the first room to move to a preset location within the field of view of the user.

Or, in some embodiments, the management module is configured to: display a second management interface in the extended reality space in response to a fourth instruction, wherein the second management interface includes a space list of captured spaces of the user, a room list of captured rooms of the captured spaces, and management controls of the captured rooms of the captured spaces; and in response to a second operation by the user on the management control of a fifth captured room of the captured space, performing the following operations on the fifth captured room: room modification and room deletion, wherein the room modification comprises one or more of the following modification operations: modifying a name of a room, resetting a space capture result of a room, adding furniture within a room, deleting furniture within a room, or modifying an anchor within a room.

In some embodiments, the second management interface further includes a room adding control, and the method further includes: adding a capturable room to the target space in response to a third operation by the user on the room adding control.

It should be understood that the apparatus embodiments and the method embodiments may correspond to each other, and similar descriptions may refer to the method embodiments. To avoid repetition, details are not described herein again.

The apparatus 100 in the embodiments of the present application is described from the perspective of a functional module in conjunction with the drawings. It should be understood that, the functional module may be implemented in the form of hardware, or may be implemented by an instruction in the form of software, or may be implemented by a combination of hardware and a software module. Specifically, the steps in the method embodiments in the embodiments of the present application may be completed by an integrated logic circuit of hardware in a processor and/or an instruction in the form of software, and the steps disclosed in the embodiments of the present application may be directly executed and completed by a hardware decoding processor, or may be executed and completed by the combination of hardware and a software module in the decoding processor. Optionally, the software module may be located in a mature storage medium in the art, such as a random access memory, a flash memory, a read-only memory, a programmable read-only memory, an electrically erasable programmable memory, a register, and the like. The storage medium is located in the memory, and the processor reads information in the memory and completes the steps in the foregoing method embodiments in combination with the hardware thereof.

An embodiment of the present application further provides an XR device. FIG. 17 is a schematic structural diagram of an XR device provided in Embodiment 6 of the present application, and as shown in FIG. 17, the XR device 200 may include: a memory 21 and a processor 22, wherein the memory 21 is configured to store a computer program, and transmit program codes to the processor 22. In other words, the processor 22 may call the computer program from the memory 21 and run the computer program, so as to implement the method in the embodiments of the present application.

For example, the processor 22 may be configured to execute the foregoing method embodiments according to instructions in the computer program.

In some embodiments of the present application, the processor 22 may include, but is not limited to: a general-purpose processor, a digital signal processor (DSP), an application specific integrated circuit (ASIC), a field programmable gate array (FPGA) or another programmable logic device, a discrete gate or transistor logic device, a discrete hardware component, or the like.

In some embodiments of the present application, the memory 21 includes, but is not limited to: a volatile memory and/or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which is used as an external cache. By way of example and not limitation, many forms of RAMs are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (synch link DRAM, SLDRAM), and a direct rambus random access memory (Direct Rambus RAM, DR RAM).

In some embodiments of the present application, the computer program may be divided into one or more modules, and the one or more modules are stored in the memory 21 and are executed by the processor 22 to complete the method provided in the present application. The one or more modules may be a series of computer program instruction segments capable of completing a specific function, and the instruction segment is used for describing an execution process of the computer program in the XR device.

As shown in FIG. 17, the XR device may further include a transceiver 23, which may be connected to the processor 22 or the memory 21.

The processor 22 may control the transceiver 23 to communicate with another device, and specifically, may send information or data to the other device, or receive information or data sent by the other device. The transceiver 23 may include a transmitter and a receiver. The transceiver 23 may further include an antenna, and there may be one or more antennas.

It can be understood that although not shown in FIG. 17, the XR device 200 may further include a camera module, a wireless fidelity (WiFi) module, a positioning module, a Bluetooth module, a display, a controller, and the like, and details are not described herein again.

It should be understood that components in the XR device are connected by using a bus system, wherein in addition to a data bus, the bus system further includes a power bus, a control bus, and a state signal bus.

The present application further provides a computer storage medium, storing a computer program thereon, wherein when the computer program is executed by a computer, the computer is enabled to execute the method in the foregoing method embodiments. Or, an embodiment of the present application further provides a computer program product, including an instruction, wherein when the instruction is executed by a computer, the computer is caused to execute the method in the foregoing method embodiments.

The present application further provides a computer program product, including a computer program, wherein the computer program is stored in a computer-readable storage medium. The processor of the XR device reads the computer program from the computer-readable storage medium, and the processor executes the computer program, so that the XR device is caused to execute a corresponding flow in a method for controlling a user location in a virtual scene in the embodiments of the present application. For conciseness, details are not described herein again.

In several embodiments provided by the present application, it should be understood that, the disclosed system, apparatus and method may be implemented in other manners. For example, the apparatus embodiments described above are merely exemplary, for example, the division of the modules is only a logic function division, there may be other division manners in practical implementations, for example, a plurality of modules or components may be combined or integrated to another system, or some features may be omitted or not executed. From another point of view, the displayed or discussed mutual coupling or direct coupling or communication connection may be indirect coupling or communication connection of apparatuses or modules through some interfaces, and may be in electrical, mechanical or other forms.

The modules described as separate components may be separated physically or not, components displayed as modules may be physical modules or not, namely, may be located in one place, or may be distributed on a plurality of network units. A part or all of the modules may be selected to implement the purposes of the solutions in the present embodiment according to actual demands. For example, functional modules in the embodiments of the present application may be integrated into one processing module, or each module may exist alone physically, or two or more modules are integrated into one module.

The foregoing descriptions are merely specific implementations of the present application, but the protection scope of the present application is not limited thereto, and changes or replacements conceivable to any skilled who is familiar with this art within the technical scope disclosed in the present application shall fall within the protection scope of the present application. Therefore, the protection scope of the present application shall be subject to the protection scope of the claims.

I/We claim:

1. A multi-room capture method, comprising:
displaying a room capture interface in response to a room capture trigger instruction, wherein the room capture interface comprises information of uncaptured rooms of a target space, and an environmental map of the target space is associable with anchors of a plurality of captured rooms within the target space;
in response to a selection operation by a user on an uncaptured target room in the room capture interface, capturing the target room according to a multi-room capture policy; and
updating environmental data of the environmental map according to a capture result of the target room, and associating an anchor of the target room with the environmental map.

2. The method according to claim 1, wherein the multi-room capture policy comprises the following:
closed spaces of any two captured rooms of the environmental map do not overlap with each other.

3. The method according to claim 2, wherein the multi-room capture policy further comprises the following:
a capture box of furniture within a room does not exceed the closed space of the room.

4. The method according to claim 2, wherein capturing the target room according to the multi-room capture policy comprises:
acquiring an image corresponding to the target room, and capturing, according to the image corresponding to the target room, the target room in an order of a floor, a wall space, a ceiling and furniture, wherein the closed space of the target room is formed by connecting capture lines of the floor, the wall space and the ceiling of the target room;
capturing the closed space of the target room; and
in response to detecting that a target capture line of the closed space of the target room overlaps with the closed space of a captured room of the environmental map, outputting first prompt information, wherein the first prompt information is used for at least one of:
prompting a location error of the target capture line, or prompting to adjust a location of the target capture line to a corrected location.

5. The method according to claim 3, wherein capturing the target room according to the multi-room capture policy comprises:
acquiring an image corresponding to the target room, and capturing, according to the image corresponding to the target room, the target room in an order of a floor, a wall space, a ceiling and furniture, wherein the closed space of the target room is formed by connecting capture lines of the floor, the wall space and the ceiling of the target room; and
in response to detecting that a capture box of target furniture within the target room exceeds the closed space of the target room, outputting second prompt information, wherein the second prompt information is used for at least one of: prompting a capture error of the target furniture, or prompting to adjust the capture box of the target furniture.

6. The method according to claim 5, wherein acquiring the image corresponding to the target room, and capturing, according to the image corresponding to the target room, the target room in the order of the floor, the wall space, the ceiling and the furniture comprises:
determining, according to the image corresponding to the target room, a perspective image corresponding to the target room;
displaying the perspective image corresponding to the target room and a closed floor area or closed space of the captured room within the target space; and
capturing the target room in the order of the floor, the wall space, the ceiling and the furniture.

7. The method according to claim 1, wherein associating the anchor of the target room with the environmental map comprises:
generating anchor information of the target room, and storing the anchor information of the target room by using an identifier of the target room as an index; and
establishing an association relationship between the identifier of the target room and an identifier of the environmental map.

8. The method according to claim 1, further comprising:
in response to receiving a first instruction, positioning the environmental map according to the environmental data of the environmental map;
in response to determining that the positioning of the environmental map succeeds, determining, according to the identifier of the environmental map, identifiers of a plurality of captured rooms that have been associated with the environmental map;
acquiring, according to the identifiers of the plurality of captured rooms that have been associated with the environmental map, anchor information of all or part of the plurality of captured rooms that have been associated with the environmental map; and
displaying acquired content of the captured rooms according to the acquired anchor information of the captured rooms.

9. The method according to claim 8, wherein acquiring, according to the identifiers of the plurality of captured rooms that have been associated with the environmental map, the anchor information of all or part of the plurality of captured rooms that have been associated with the environmental map comprises:
determining, according to a loading rule and from the identifiers of the plurality of captured rooms that have been associated with the environmental map, an identifier of a second captured room to be loaded; and
loading the anchor information of the second captured room into a memory according to the identifier of the second captured room.

10. The method according to claim 8, further comprising:
in response to detecting that the user moves from a third captured room to a fourth captured room, acquiring anchor information of the fourth captured room according to an identifier of the fourth captured room; and
displaying content of the fourth captured room according to the anchor information of the fourth captured room.

11. The method according to claim 10, wherein displaying the content of the fourth captured room according to the anchor information of the fourth captured room comprises:
according to the anchor information of the fourth captured room, displaying the content of the fourth captured room, and displaying a semitransparent mask layer on a capture plane of a captured object within the fourth captured room.

12. The method according to claim 1, further comprising:
displaying a first management interface in an extended reality space in response to a second instruction, wherein the first management interface comprises a space list of captured spaces of the user, a room list of captured rooms of the captured spaces, and a 2D view of a space layout of a first captured space, and the first captured space belongs to a space of the captured spaces of the user.

13. The method according to claim 12, further comprising:
displaying a 3D view of the space layout of the first captured space in the extended reality space in response to a third instruction.

14. The method according to claim 13, wherein the first captured space is a space where the user is located currently, and an identifier of a current location of the user is further displayed in the 2D view of the space layout of the first captured space; and
wherein displaying the 3D view of the space layout of the first captured space in response to the third instruction comprises:
displaying the 3D view of the space layout of the first captured space in the first management interface in response to detecting that the user moves from a first room to a second room in the first captured space.

15. The method according to claim 13, further comprising:
displaying, in the extended reality space, a 3D model of the first room in the first captured space in response to a 3D model evocation instruction.

16. The method according to claim 15, further comprising:
upon detecting a first operation, controlling the 3D model of the first room to enter an editing state, wherein the 3D model of the first room is displayed with a preset effect after the 3D model of the first room enters the editing state; and
upon detecting a second operation, controlling the 3D model of the first room to rotate.

17. The method according to claim 15, wherein the first captured space is a space where the user is located currently, the first room is a room where the user is located currently, and the method further comprises:
in response to detecting that a rotation angle of a head-mounted device is greater than a preset angle or the 3D model of the first room exceeds a field of view of the user, controlling, according to a current location of the user, the 3D model of the first room to move to a preset location within the field of view of the user.

18. The method according to claim 1, further comprising:
displaying a second management interface in the extended reality space in response to a fourth instruction, wherein the second management interface comprises a space list of captured spaces of a user, a room list of captured rooms of the captured spaces, and management controls of the captured rooms of the captured spaces; and
in response to a second operation by the user on the management control of a fifth captured room of the captured space, performing the following operations on the fifth captured room: room modification and room deletion, wherein the room modification comprises one or more of the following modification operations: modifying a name of a room, resetting a space capture result of a room, adding furniture within a room, deleting furniture within a room, or modifying an anchor within a room.

19. An extended reality device, comprising:
a processor and a memory, wherein the memory is configured to store a computer program, and the processor is configured to call and run the computer program stored in the memory, so as to be caused to:
display a room capture interface in response to a room capture trigger instruction, wherein the room capture interface comprises information of uncaptured rooms of a target space, and an environmental map of the target space is associable with anchors of a plurality of captured rooms within the target space;
in response to a selection operation by a user on an uncaptured target room in the room capture interface, capture the target room according to a multi-room capture policy; and
update environmental data of the environmental map according to a capture result of the target room, and associate an anchor of the target room with the environmental map.

20. A non-volatile computer-readable storage medium, wherein the computer-readable storage medium is configured to store a computer program, and the computer program causes a computer to:
display a room capture interface in response to a room capture trigger instruction, wherein the room capture interface comprises information of uncaptured rooms of a target space, and an environmental map of the target space is associable with anchors of a plurality of captured rooms within the target space;
in response to a selection operation by a user on an uncaptured target room in the room capture interface, capture the target room according to a multi-room capture policy; and
update environmental data of the environmental map according to a capture result of the target room, and associate an anchor of the target room with the environmental map.
